(19) United States
(12) Patent Application Publication
(10) Pub. No.: US 2025/0369062 A1
(43) Pub. Date: Dec. 4, 2025

(54) METHOD FOR REDUCING CONTENT OF MNS INCLUSIONS IN STEEL

(71) Applicants: HENGLILAI NEW MATERIALS LIMITED, Yuzhou (CN); TIANRUN INDUSTRY TECHNOLOGY CO., LTD., Weihai (CN)

(72) Inventors: Jianchen CONG, Yuzhou (CN); Yufang Wang, Yuzhou (CN); Jing Wang, Yuzhou (CN); Dong Lin, Yuzhou (CH); Yangfan Zhou, Yuzhou (CN); Shibo Shao, Yuzhou (CN)

(21) Appl. No.: 18/976,509

(22) Filed: Dec. 11, 2024

(30) Foreign Application Priority Data
Jun. 3, 2024 (CN) 202410704097.8

(51) Int. Cl. C21C 7/00; C21C 7/10

(52) U.S. Cl. CPC C21C 7/0006; C21C 7/10

(57) ABSTRACT

The invention provides a method for reducing content of MnS inclusions in steel, including: (1) placing raw materials of other elements than manganese in a smelting furnace according to components of steel to perform smelting to obtain liquid steel; (2) first adding a first rare earth element and sulfur to the liquid steel, to form rare earth sulphide, then adding a raw material containing manganese to perform smelting, performing tapping after smelting is completed, and performing pouring and cooling to obtain a cast ingot. A rare earth element and sulfur are first added to liquid steel before manganese is added to generate tiny, round rare earth sulphide, and subsequently manganese is added to make it difficult to generate MnS, so that MnS and rare earth/manganese/sulfur composite inclusions are reduced, and content of MnS inclusions at a parting plane of a workpiece is reduced, thereby improving the reliability of the workpiece.

This application claims priority to Chinese Patent Application No. 202410704097.8, filed on Jun. 3, 2024, which is incorporated by reference for all purposes as if fully set forth herein.

### FIELD OF THE INVENTION

The present invention relates to the field of steel smelting technology, and specifically to a method for reducing content of MnS inclusions in steel.

### DESCRIPTION OF THE RELATED ART

Currently, a certain quantity of MnS inclusions exist in common structural steel. The MnS inclusions in the steel are plastic inclusions, and are stretched in a deformation direction in a rolling and forging process to form strip-shaped or chain-like MnS inclusions, which become stress concentration points in a use process, affecting product reliability. To solve the problem, researchers have carried out research on modification technologies using inclusions of different types. For example, a rare earth is added to steel to form inclusions of Ce—O—S and Ce—S types with weak deformability, the principle of which is that the rare earth has higher activity than that of manganese, and removes S from MnS. The MnS inclusions have three states: (1) Overall modification occurs from outside an MnS inclusion. In other words, cerium gradually reacts with the MnS inclusion from outside to inside (as shown in FIG. 1). (2) Cerium gathers on a side of an MnS inclusion, and reacts with the MnS inclusion to generate a CeS inclusion (as shown in FIG. 2). (3) Cerium starts to react from the center of an inclusion, and reacts with remaining MnS on two sides after MnS at the center is completely modified (as shown in FIG. 3).

Directly adding a rare earth element to steel is one of the major manners of reducing MnS inclusions in steel at present. For example, Patent CN111560496A discloses a method for refining MnS inclusions in the whole process of casting and rolling ultra-low carbon IF steel by rare earth treatment. A large amount of a rare earth-cerium alloy is added in a final phase of RH refining to react with S to generate different forms of sulphide, and adsorb manganese sulphide inclusions nearby. Although tiny circular or elliptical rare earth sulphide and rare earth oxysulfide are formed in the method, the foregoing inclusions in three states are generated, and such rare earth inclusions that have large sizes, edges, and irregular shapes also adversely affect the quality and performance of steel. Therefore, there is an urgent need for a more effective method for reducing content of MnS inclusions in steel.

### SUMMARY OF THE INVENTION

A technical problem to be resolved by the present invention is to provide a method for reducing content of MnS inclusions in steel. A rare earth and sulfur are first added to steel before manganese is added, and manganese is added after rare earth sulphide is generated, to avoid generation of manganese sulphide. In addition, the density of the rare earth sulphide formed in liquid iron is close to the density of liquid steel, and the rare earth sulphide is not likely to gather, to form scattered tiny inclusions in steel, so that the cuttability of the steel can be effectively improved, and subsequently the reliability of a workpiece is also ensured.

To resolve the foregoing technical problems, the present invention provides the technical solutions as follows:

A first aspect of the present invention provides a method for reducing content of MnS inclusions in steel, including the following steps:
(1) placing raw materials of other elements than manganese in a smelting furnace according to components of steel to perform smelting to obtain liquid steel; and
(2) first adding a first rare earth element and sulfur to the liquid steel, to form rare earth sulphide, then adding a raw material containing manganese to perform smelting, performing tapping after smelting is completed, and performing pouring and cooling to obtain a cast ingot.

The density of manganese sulphide (MnS) is 4 g/cm³, and is greatly different from the density of the liquid steel being 6.7 g/cm³. In a process of molten steel crystallization, manganese sulphide tends to float upward and gather, and MnS inclusions are plastic inclusions, and are stretched in a deformation direction in a rolling and forging process to form strip-shaped or chain-like MnS inclusions, which become stress concentration points in a use process, affecting product reliability. In the present invention, raw materials of other elements than manganese in steel are first smelted, then the first rare earth element and the sulfur are added to obtain liquid steel to produce tiny, round rare earth sulphide, and then a raw material containing manganese is added to make it difficult to generate MnS, thereby effectively reducing a quantity of MnS inclusions. In addition, the generation of large-size rare earth-manganese-sulfur composite inclusions is also effectively inhibited, and the generated rare earth sulphide has a density close to the density of liquid steel (for example, the density of CeS is 6.3 g/cm³) and can be uniformly scattered in molten iron. In the process of molten steel crystallization, rare earth sulphide does not tend to gather at the core of steel, to form scattered tiny inclusions in the steel.

Preferably, in Step (1), the smelting furnace is a vacuum smelting furnace, and the smelting is performed in an argon atmosphere.

Preferably, in Step (1), the steel is preferably selected from the steel of the following designation: 40Cr, 35CrMo, 42CrMo, 40CrNiMo, 50CrMo, 48MnV, C38, C38N2, 38MnVS6, or S38MnSiV.

Preferably, in Step (2), a mass ratio of the first rare earth element to the sulfur added to the liquid steel is 1:0.2 to 1:0.4, and is, for example, 1:0.3.

Preferably, in Step (2), the first rare earth element is cerium and/or lanthanum.

Preferably, the first rare earth element is preferably cerium.

Preferably, in Step (2), an addition amount of the sulfur accounts for 0.02 wt % to 0.05 wt % of the steel.

Preferably, in Step (2), before adding a first rare earth element and sulfur to the liquid steel the method further comprises performing drossing treatment on the liquid steel.

In the present invention, drossing treatment is performed on the liquid steel in advance before the first rare earth element and the sulfur are added to remove various inclusions in the liquid steel, and then the first rare earth element and the sulfur are added to pure molten iron, to generate tiny, round rare earth sulphide. Without beforehand drossing treatment, excessive types and quantities of inclusions exist in liquid steel, affecting the reliability of steel. If drossing treatment is performed after the first rare earth element and the sulfur are added, the generated rare earth sulphide is susceptible to a loss in a drossing process.

Preferably, in Step (2), a second rare earth element is added to the liquid steel before the tapping, and an addition amount of the second rare earth element accounts for 0.01 wt % to 0.03 wt % of the cut steel. The proportion of rare earth sulphide can be further increased by adding the second rare earth element before tapping, to reduce the proportion of manganese sulphide inclusions.

Preferably, the second rare earth element is cerium and/or lanthanum.

Preferably, the second rare earth element is preferably cerium.

Preferably, an amount of the rare earth sulphide particles in the cast ingot accounts for more than 85% of a total quantity of inclusions.

Preferably, a quantity of inclusions with sizes less than 2 μm in the cast ingot accounts for more than 70% of a total quantity of inclusions.

The beneficial effects of the present invention are as follows:

1. The present invention provides a method for reducing content of MnS inclusions in steel. In a smelting process of liquid steel, raw materials of other elements than manganese are first smelted, then a rare earth element and sulfur are added to obtain liquid steel to form a large amount of tiny, round rare earth sulphide, and then a raw material containing manganese is added to perform smelting. Through the foregoing method of adding a rare earth and sulfur to liquid steel before manganese is added, a quantity of manganese sulphide inclusions in the liquid steel is effectively reduced. In a subsequent process of forging a workpiece from the steel, because manganese sulphide inclusions at a parting plane of the workpiece are greatly reduced, the reliability of the workpiece is effectively improved. In addition, formed tiny inclusions are scattered in the steel, thereby improving the cuttability of the steel.

2. In the method for reducing content of MnS inclusions in steel in the present invention, operations are simple, a small amount of rare earths is required, and costs are low. Prepared steel has a small quantity of manganese sulphide inclusions and a large quantity of rare earth sulphide inclusions (>85%), and a proportion of inclusions with small sizes of 1 μm to 2 μm reaches over 70%, thereby effectively improving the cutting performance of the steel and the reliability of a workpiece prepared from the steel.

### BRIEF DESCRIPTION OF THE DRAWINGS

FIG. 1 is an electronic image and element distribution before and after modification using cerium from outside of an MnS inclusion;

FIG. 2 is an electronic image and element distribution before and after modification using cerium from a side of an MnS inclusion;

FIG. 3 is an electronic image and element distribution before and after modification using cerium from the center of an MnS inclusion;

FIG. 4 is an electronic image of an inclusion in steel prepared in Example 3;

FIG. 5 is an electronic image of an inclusion in steel prepared in Comparative example 2;

FIG. 6 is a picture of performing magnetic particle testing on a crankshaft obtained by processing steel prepared in Comparative example 2; and

FIG. 7 shows steel scraps generated from cutting experiments performed after forging and quenching and tempering treatment of steel ingots prepared in Examples 1 to 3 and Comparative examples 1 to 3.

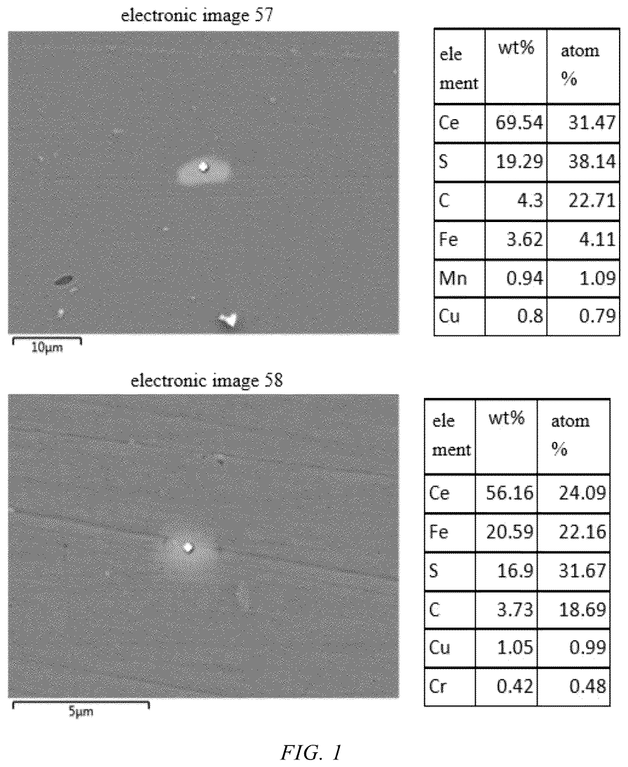

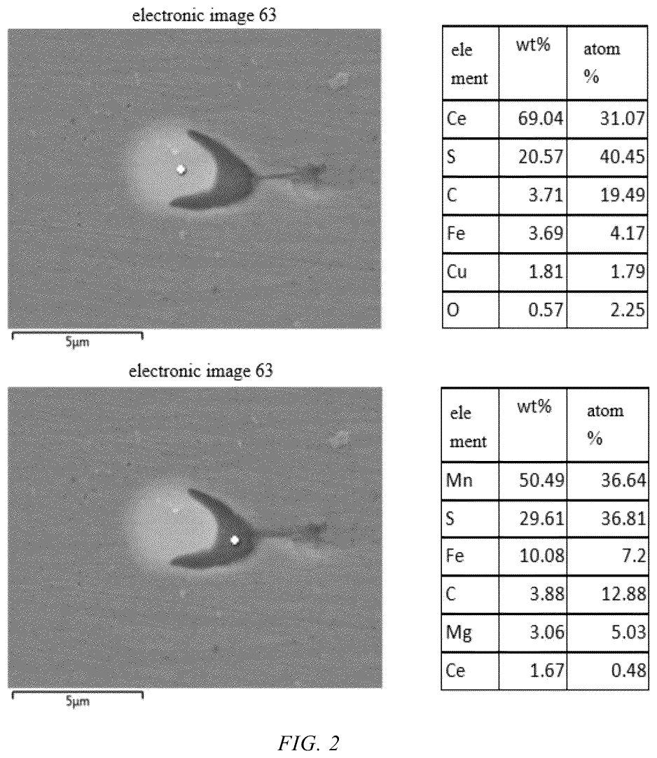

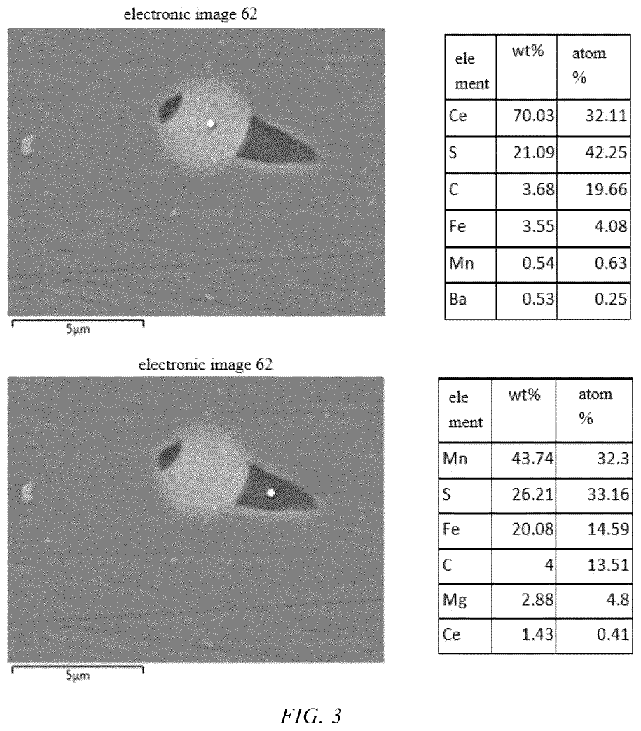

### DETAILED DESCRIPTION OF THE PREFERRED EMBODIMENTS

Unless otherwise defined, all technical and scientific terms used herein have the same meanings as those generally understood by a person skilled in the art. The terms used in the specification of the present disclosure are only for the purpose of describing specific embodiments, and are not intended to limit the present disclosure. The term “and/or” used herein encompasses any and all possible combinations of one or more of the associated listed items.

The present invention is further described below with reference to the accompanying drawings and specific embodiments, to enable a person skilled in the art to better understand and implement the present invention. However, the embodiments are not used to limit the present invention.

The following examples and comparative examples involve the preparation of steel with a designation of 42CrMo. Weight percentages of elements in the steel are shown in Table 1.

TABLE 1
Elemental composition of steel 42CrMo

| Elements | C | Si | Mn | P | Cr | Mo | Ni | Cu |
|---|---|---|---|---|---|---|---|---|
| Weight | 0.38-0.45 | 0.17-0.37 | 0.50-0.80 | ≤0.035 | 0.90-1.20 | 0.15-0.25 | ≤0.30 | ≤0.30 |
| percentage | | | | | | | | |
| % | | | | | | | | |

### EXAMPLE 1

This example involves the preparation of steel 42CrMo. A specific preparation method is as follows:
(1) The weighed pure iron rods, carbon, ferrochrome, and ferromolybdenum were added into a 25-kg vacuum smelting furnace, the furnace was turned off and vacuumized to 4×10⁼² Pa, argon was introduced at a pressure of −0.03 MPa to perform gas washing, and the furnace was vacuumized again to make the pressure reach 4×10⁻² Pa, argon was introduced again at a pressure of −0.06 MPa, and then smelting was started;
(2) when the temperature of the smelting furnace reached 1500° C. to 1550° C., ferrosilicon, cerium, pyrite, and ferromanganese were sequentially stringed from bottom to top on an elevation mechanism with an iron wire, observation was performed through an observation window, a hand wheel was turned to perform sequential addition, the pyrite was added, and 1 minute later the ferromanganese was added to ensure complete nucleation and growth of cerium sulphide, the components were uniformly mixed in liquid iron through electromagnetic stirring, and the temperature was kept between 1500°° C. to 1550° C. for 15 min; and
(3) liquid steel in the smelting furnace was poured into a mold after smelting is completed, and cooling was performed to form a cast ingot with a diameter of 90 mm.

In Step (2) in this example, the content of the added cerium accounted for 0.1% of the total weight of the cast ingot, the content of sulfur in the added pyrite accounted for 0.02% of the total weight of the cast ingot, and the content of manganese in the added ferromanganese accounted for 0.7% of the total weight of the cast ingot.

The mass percentages of the elements in the steel prepared in this example are shown in Table 2 below.

TABLE 2
Elemental composition of steel 42CrMo

| Elements | C | Si | Mn | P | S | Cr | Mo | Ni | Cu | Ce |
|---|---|---|---|---|---|---|---|---|---|---|
| Weight | 0.42 | 0.25 | 0.70 | 0.012 | 0.02 | 1.15 | 0.21 | 0.02 | 0.02 | 0.10 |
| percentage | | | | | | | | | | |
| % | | | | | | | | | | |

### EXAMPLE 2

This example involves the preparation of steel 42CrMo. Differences from Example 1 lie in amounts and a sequence of adding pyrite, cerium, and ferromanganese in Step (2). Details are as follows:
when the temperature of the smelting furnace reached 1500° C. to 1550° C., ferrosilicon, pyrite, cerium, ferromanganese, and cerium were sequentially stringed from bottom to top on an elevation mechanism with an iron wire, observing was performed through an observation window, a hand wheel was turned to perform sequential addition, cerium was added, 1 minute later ferromanganese was added to ensure complete nucleation and growth of cerium sulphide, the components were uniformly mixed in liquid iron through electromagnetic stirring, and the temperature was kept between 1500° C. to 1550° C. for 15 min.

In this example, the content of sulfur in the added pyrite accounted for 0.03% of the total weight of the cast ingot, the content of the cerium added for the first time accounted for 0.08% of the total weight of the cast ingot, the content of manganese in the added ferromanganese accounted for 0.7% of the total weight of the cast ingot, and the content of the cerium added for the second time accounted for 0.03% of the total weight of the cast ingot.

The mass percentages of the elements in the steel prepared in this example are shown in Table 3 below.

TABLE 3
Elemental composition of steel 42CrMo

| Elements | C | Si | Mn | P | S | Cr | Mo | Ni | Cu | Ce |
|---|---|---|---|---|---|---|---|---|---|---|
| Weight | 0.40 | 0.21 | 0.7 | 0.008 | 0.03 | 1.11 | 0.20 | 0.006 | 0.03 | 0.11 |
| percentage | | | | | | | | | | |
| % | | | | | | | | | | |

### EXAMPLE 3

This example involves the preparation of steel 42CrMo. Differences from Example 1 lie in amounts and a sequence of adding pyrite, cerium, and ferromanganese in Step (2). Details are as follows:
when the temperature of the smelting furnace reached 1500° C. to 1550° C., ferrosilicon, pyrite, cerium, ferromanganese, and cerium were sequentially stringed from bottom to top on an elevation mechanism with an iron wire, observing was performed through an observation window, a hand wheel was turned to perform sequential addition, cerium was added, 1 minute later ferromanganese was added to ensure complete nucleation and growth of cerium sulphide, the components were uniformly mixed in liquid iron through electromagnetic stirring, and the temperature was kept between 1500° C. to 1550° C. for 15 min.

In this example, the content of sulfur in the added pyrite accounted for 0.04% of the total weight of the cast ingot, the content of the cerium added for the first time accounted for 0.1% of the total weight of the cast ingot, the content of manganese in the added ferromanganese accounted for 0.6% of the total weight of the cast ingot, and the content of the cerium added for the second time accounted for 0.01% of the total weight of the cast ingot.

The mass percentages of the elements in the steel prepared in this example are shown in Table 4 below.

TABLE 4
Elemental composition of steel 42CrMo

| Elements | C | Si | Mn | P | S | Cr | Mo | Ni | Cu | Ce |
|---|---|---|---|---|---|---|---|---|---|---|
| Weight | 0.44 | 0.22 | 0.6 | 0.011 | 0.04 | 1.02 | 0.18 | 0.011 | 0.027 | 0.11 |
| percentage | | | | | | | | | | |
| % | | | | | | | | | | |

### EXAMPLE 4

This example involves the preparation of steel 42CrMo. Differences between this example and Example 1 lie in amounts and a sequence of adding pyrite, cerium, and ferromanganese in Step (2). Details are as follows:
when the temperature of the smelting furnace reached 1500° C. to 1550° C., ferrosilicon, pyrite, cerium, ferromanganese, and cerium were sequentially stringed from bottom to top on an elevation mechanism with an iron wire, observing was performed through an observation window, a hand wheel was turned to perform sequential addition, cerium was added, 1 minute later ferromanganese was added to ensure complete nucleation and growth of cerium sulphide, the components were uniformly mixed in liquid iron through electromagnetic stirring, and the temperature was kept between 1500° C. to 1550° C. for 15 min.

In this example, the content of sulfur in the added pyrite accounted for 0.05% of the total weight of the cast ingot, the content of the cerium added for the first time accounted for 0.15% of the total weight of the cast ingot, the content of manganese in the added ferromanganese accounted for 0.7% of the total weight of the cast ingot, and the content of the cerium added for the second time accounted for 0.01% of the total weight of the cast ingot.

The mass percentages of the elements in the steel prepared in this example are shown in Table 5 below.

TABLE 5
Elemental composition of steel 42CrMo

| Elements | C | Si | Mn | P | S | Cr | Mo | Ni | Cu | Ce |
|---|---|---|---|---|---|---|---|---|---|---|
| Weight | 0.43 | 0.31 | 0.7 | 0.011 | 0.05 | 0.99 | 0.19 | 0.008 | 0.016 | 0.16 |
| percentage | | | | | | | | | | |
| % | | | | | | | | | | |

### COMPARATIVE EXAMPLE 1

This comparative example involves the preparation of steel 42CrMo. A difference from Example 1 lies in that neither of pyrite and cerium is added in Step (2). Details are as follows:
when the temperature of the smelting furnace reached 1500° C. to 1550° C., ferrosilicon and ferromanganese were sequentially stringed from bottom to top on an elevation mechanism with an iron wire, observing was performed through an observation window, a hand wheel was turned to perform sequential addition, the components were uniformly mixed in liquid iron through electromagnetic stirring, and the temperature was kept between 1500° C. to 1550° C. for 15 min.

In this comparative example, the content of manganese in the added ferromanganese accounted for 0.7% of the total weight of the cast ingot.

The mass percentages of the elements in the steel prepared in this comparative example are shown in Table 6 below.

TABLE 6
Elemental composition of steel 42CrMo

| Elements | C | Si | Mn | P | Cr | Mo | Ni | Cu |
|---|---|---|---|---|---|---|---|---|
| Weight | 0.41 | 0.23 | 0.7 | 0.01 | 1.12 | 0.20 | 0.016 | 0.008 |
| percentage | | | | | | | | |
| % | | | | | | | | |

### COMPARATIVE EXAMPLE 2

This comparative example involves the preparation of steel 42CrMo. A difference from Example 1 lies in a sequence of adding pyrite, cerium, and ferromanganese in Step (2). The pyrite and the ferromanganese are added before the cerium is added. Details are as follows:
When the temperature of the smelting furnace reached 1500° C. to 1550° C., ferrosilicon, pyrite, ferromanganese, and cerium were sequentially stringed from bottom to top on an elevation mechanism with an iron wire, observing was performed through an observation window, a hand wheel was turned to perform sequential addition, the components were uniformly mixed in liquid iron through electromagnetic stirring, and the temperature was kept between 1500° C. to 1550° C. for 15 min.

In this comparative example, the content of sulfur in the added pyrite accounted for 0.05% of the total weight of the cast ingot, the content of manganese in the added ferromanganese accounted for 0.7% of the total weight of the cast ingot, and the content of the added cerium accounted for 0.04% of the total weight of the cast ingot.

The mass percentages of the elements in the steel prepared in this comparative example are shown in Table 7 below.

TABLE 7
Elemental composition of steel 42CrMo

| Elements | C | Si | Mn | P | S | Cr | Mo | Ni | Cu | Ce |
|---|---|---|---|---|---|---|---|---|---|---|
| Weight | 0.40 | 0.21 | 0.7 | 0.012 | 0.05 | 1.15 | 0.22 | 0.016 | 0.008 | 0.04 |
| percentage | | | | | | | | | | |
| % | | | | | | | | | | |

### COMPARATIVE EXAMPLE 3

This comparative example involves the preparation of steel 42CrMo. A difference from Example 1 lies in that cerium is not added in Step (2). Details are as follows:
When the temperature of the smelting furnace reached 1500° C. to 1550° C., ferrosilicon, pyrite, and ferromanganese were sequentially stringed from bottom to top on an elevation mechanism with an iron wire, observing was performed through an observation window, a hand wheel was turned to perform sequential addition, the components were uniformly mixed in liquid iron through electromagnetic stirring, and the temperature was kept between 1500° C. to 1550° C. for 15 min.

In this comparative example, the content of sulfur in the added pyrite accounted for 0.04% of the total weight of the cast ingot, and the content of manganese in the added ferromanganese accounted for 0.6% of the total weight of the cast ingot.

The mass percentages of the elements in the steel prepared in this comparative example are shown in Table 8 below.

TABLE 8
Elemental composition of steel 42CrMo

| Elements | C | Si | Mn | P | S | Cr | Mo | Ni | Cu |
|---|---|---|---|---|---|---|---|---|---|
| Weight | 0.44 | 0.22 | 0.6 | 0.014 | 0.04 | 1.11 | 0.23 | 0.012 | 0.015 |
| percentage | | | | | | | | | |
| % | | | | | | | | | |

Specific components of the steel prepared in the foregoing examples and comparative examples are shown in Table 9 below:

TABLE 9
Lists of the components of the steel prepared in
the examples and the comparative examples (wt %)

| | | | | | | | | | | | Fe and |
|---|---|---|---|---|---|---|---|---|---|---|---|
| Sample | C | Si | Mn | P | S | Cr | Mo | Ni | Cu | Ce | impurities |
| Example 1 | 0.42 | 0.25 | 0.70 | 0.012 | 0.02 | 1.15 | 0.21 | 0.02 | 0.02 | 0.10 | Remainder |
| Example 2 | 0.40 | 0.21 | 0.7 | 0.008 | 0.03 | 1.11 | 0.20 | 0.006 | 0.03 | 0.11 | Remainder |
| Example 3 | 0.44 | 0.22 | 0.6 | 0.011 | 0.04 | 1.02 | 0.18 | 0.011 | 0.027 | 0.11 | Remainder |
| Example 4 | 0.43 | 0.31 | 0.7 | 0.011 | 0.05 | 0.99 | 0.19 | 0.008 | 0.016 | 0.16 | Remainder |
| Comparative | 0.41 | 0.23 | 0.7 | 0.01 | / | 1.12 | 0.20 | 0.016 | 0.008 | / | Remainder |
| example 1 | | | | | | | | | | | |
| Comparative | 0.40 | 0.21 | 0.7 | 0.012 | 0.05 | 1.15 | 0.22 | 0.016 | 0.008 | 0.04 | Remainder |
| example 2 | | | | | | | | | | | |
| Comparative | 0.44 | 0.22 | 0.6 | 0.014 | 0.04 | 1.11 | 0.23 | 0.012 | 0.015 | / | Remainder |
| example 3 | | | | | | | | | | | |

Types and size proportions of inclusions in the steel prepared in the foregoing examples and comparative examples are shown in Table 10:

TABLE 10
Table of types of inclusions and proportions of
inclusions of different sizes in the steel prepared
in the examples and the comparative examples

| | Sizes and types of inclusions | | | | | | |
|---|---|---|---|---|---|---|---|
| | | | | | Quantity | | |
| | | | | | proportions % | | |
| | 1-2 | 2-5 | 5-10 | >10 | of inclusions | | |
| | μm | μm | μm | μm | MnS | CeS | CeO |
| Example 1 | 71.93% | 25.79% | 1.62% | 0.66% | 10.36 | 85.46 | 0.43 |
| Example 2 | 77.55% | 21.88% | 0.54% | 0.03% | 11.22 | 87.23 | 0.61 |
| Example 3 | 76.95% | 19.05% | 3.74% | 0.26% | 9.57 | 88.63 | 0.35 |
| Example 4 | 72.87% | 22.32% | 3.30% | 1.52% | 6.23 | 92.19 | 0.54 |
| Compara- | 55.03% | 35.17% | 8.52% | 1.27% | 54.76 | 0 | 0 |
| tive | | | | | | | |
| example 1 | | | | | | | |
| Compara- | 44.34% | 47.51% | 7.79% | 0.35% | 75.74 | 22.4 | 0.11 |
| tive | | | | | | | |
| example 2 | | | | | | | |
| Compara- | 36.69% | 55.84% | 7.14% | 0.34% | 92.95 | 0 | 0 |
| tive | | | | | | | |
| example 3 | | | | | | | |

Note: Only major inclusions MnS, CeS, and CeO are listed in Table 10, and other inclusions are not listed.

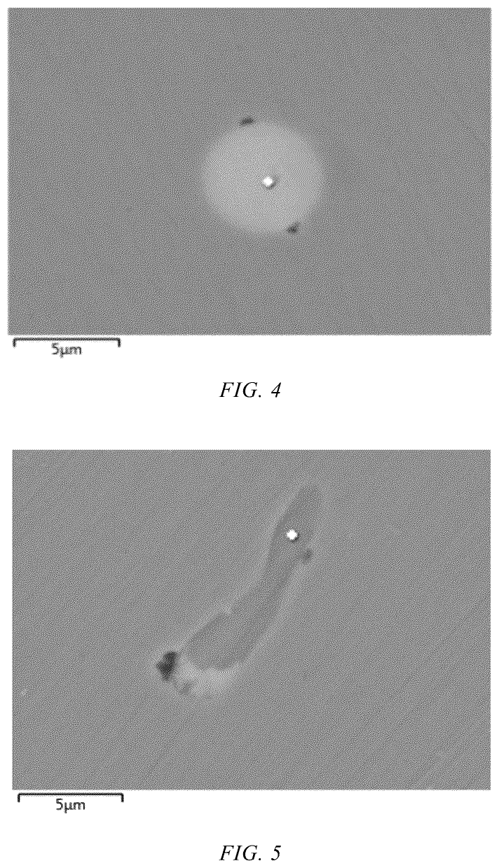

As can be learned from Table 10, in the steel prepared by using the method for reducing content of MnS inclusions in steel in the present invention, a quantity proportion of MnS in the inclusions is clearly reduced, the inclusions are mainly rare earth sulphide (with a proportion greater than 85%), and the sizes of most of the inclusions are less than 2 μm (with a proportion greater than 70%). FIG. 4 is an electronic image of an inclusion in steel prepared in Example 3. The round white inclusion in the figure is CeS, and a very small amount of MnS is adsorbed at the edge of CeS. FIG. 5 is an electronic image of an inclusion in steel prepared in Comparative example 2. A lot of MnS can be observed. It indicates that the sequence of adding sulfur, a rare earth element, and manganese directly affects the types of the inclusions and the size distribution of the inclusions in the steel.

The present invention further tests the density of the inclusions in the steel prepared in the foregoing examples and comparative examples. Test results are shown in Table 11 below:

TABLE 11
List of density of inclusions in the steel prepared in the examples and the comparative examples

| | | | | | Comparative | Comparative | Comparative |
|---|---|---|---|---|---|---|---|
| Item | Example 1 | Example 2 | Example 3 | Example 4 | example 1 | example 2 | example 3 |
| Number | 215.03 | 187.18 | 206.15 | 237.87 | 99.54 | 126.26 | 133.46 |
| density of | | | | | | | |
| inclusions | | | | | | | |
| (pieces/mm²) | | | | | | | |
| Average value | | | | | | | |

| | | |
|---|---|---|
| (pieces/mm²) | 211.56 | 119.75 |

As can be learned from Table 11, in the steel prepared by using the method for reducing content of MnS inclusions in steel in the present invention, the number density of inclusions in the steel is significantly increased, and the inclusions are mainly tiny rare earth sulphide CeS. Because the density of CeS is 6.3 g/cm³ and is close to the density of liquid steel, CeS can be scattered in the steel.

Magnetic particle testing is performed on crankshafts obtained by processing the steel prepared in the foregoing examples and comparative examples. Results are shown in Table 12 below:

TABLE 12
Summary table of occurrence ratios of magnetic particle
indications of crankshafts prepared from different steel

| | | | | | Comparative | Comparative | Comparative |
|---|---|---|---|---|---|---|---|
| Sample | Example 1 | Example 2 | Example 3 | Example 4 | example 1 | example 2 | example 3 |
| Occurrence | 0.35 | 0.22 | 0.74 | 0.51 | 32.45 | 16.77 | 41.13 |
| ratio % | | | | | | | |

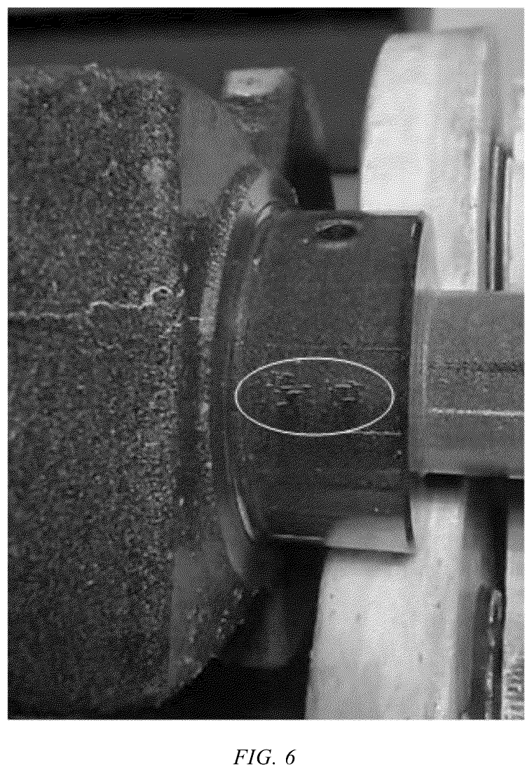

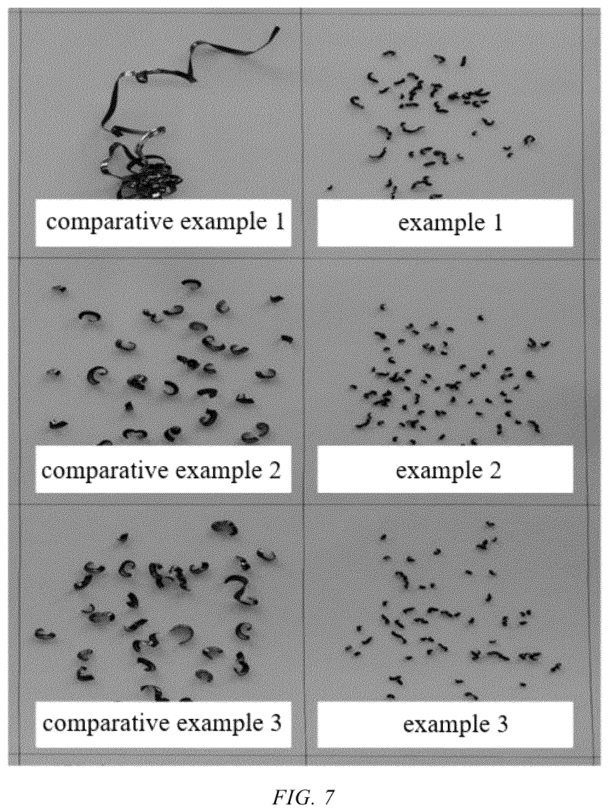

As can be learned from Table 12, nearly no magnetic particle indication exist in the crankshafts obtained by processing the steel prepared in Examples 1 to 4. However, many magnetic particle indications appear in the crankshafts obtained by processing the steel prepared in Comparative examples 1 to 3. The magnetic particle indications are shown by the circled part in FIG. 6 (the crankshaft prepared with the steel prepared in Comparative example 1). The reason is that the steel prepared in Comparative examples 1 to 3 has high content of manganese sulphide. Manganese sulphide has good plasticity and deforms accordingly along with material deformation in a forging or rolling process of steel. To be specific, manganese sulphide becomes elongated after forging or rolling, and flows to a parting plane after forging into a crankshaft to cause magnetic particle indications, affecting the reliability of a workpiece.

In the present invention, cuttability experiments are performed after forging and quenching and tempering treatment of steel ingots prepared in Examples 1 to 3 and Comparative examples 1 to 3. Under the same cutting process, cuttability is determined according to sizes of steel scraps. Smaller steel scraps indicate better cuttability of corresponding steel. Experimental results of cutting are shown in Table 7. Steel scraps corresponding to Examples 1 to 3 are clearly smaller than those in the comparative examples. This also indicates that the use of the method for reducing content of MnS inclusions in steel in the present invention can effectively improve the cuttability of steel.

The foregoing embodiments are merely preferred embodiments used to fully describe the present invention, and the protection scope of the present invention is not limited thereto. Equivalent replacements or variations made by a person skilled in the art to the present invention all fall within the protection scope of the present invention. The protection scope of the present invention is as defined in the claims.

What is claimed is:

1. A method for reducing content of MnS inclusions in steel, comprising steps of:
(1) placing raw materials of other elements than manganese in a smelting furnace according to components of steel to perform smelting to obtain liquid steel; and
(2) first adding a first rare earth element and sulfur to the liquid steel, to form rare earth sulphide, then adding a raw material containing manganese to perform smelting, performing tapping after smelting is completed, and performing pouring and cooling to obtain a cast ingot.

2. The method for reducing content of MnS inclusions in steel according to claim 1, wherein in Step (1), the smelting furnace is a vacuum smelting furnace, and the smelting is performed in an argon atmosphere.

3. The method for reducing content of MnS inclusions in steel according to claim 1, wherein in Step (1), a designation of the steel is 40Cr, 35CrMo, 42CrMo, 40CrNiMo, 50CrMo, 48MnV, C38, C38N2, 38MnVS6 or S38MnSiV.

4. The method for reducing content of MnS inclusions in steel according to claim 1, wherein in Step (2), a mass ratio of the first rare earth element to the sulfur added to the liquid steel is 1:0.2 to 1:0.4.

5. The method for reducing content of MnS inclusions in steel according to claim 1, wherein in Step (2), the first rare earth element is cerium and/or lanthanum.

6. The method for reducing content of MnS inclusions in steel according to claim 1, wherein in Step (2), an addition amount of the sulfur accounts for 0.02 wt % to 0.05 wt % of the steel.

7. The method for reducing content of MnS inclusions in steel according to claim 1, wherein in Step (2), before adding a first rare earth element and sulfur to the liquid steel the method further comprises performing drossing treatment on the liquid steel.

8. The method for reducing content of MnS inclusions in steel according to claim 1, wherein in Step (2), a second rare earth element is added to the liquid steel before the tapping, and an addition amount of the second rare earth element accounts for 0.01 wt % to 0.03 wt % of the steel.

9. The method for reducing content of MnS inclusions in steel according to claim 8, wherein the second rare earth element is cerium and/or lanthanum.

10. The method for reducing content of MnS inclusions in steel according to claim 1, wherein an amount of the rare earth sulphide particles in the cast ingot accounts for more than 85% of a total quantity of inclusions.
